(19) United States
(12) Patent Application Publication
(10) Pub. No.: US 2019/0126720 A1
(43) Pub. Date: May 2, 2019

(54) INTELLIGENT HVAC SYSTEM FOR EFFECTIVE PASSENGER CABIN AIRFLOW DISTRIBUTION

(71) Applicant: FORD GLOBAL TECHNOLOGIES, LLC, Dearborn, MI (US)

(72) Inventors: Francisco Javier Gomez Mata, Cuajimalpa de Morelos (MX); Virginia Ortega Conde, ciudad de mexico (MX); Luis Felipe Blas Martinez, JILOTEPEC (MX); Christopher Diaz Rodriguez, Mexico (MX)

(21) Appl. No.: 15/800,332

(22) Filed: Nov. 1, 2017

(51) Int. Cl. B60H 1/00

(52) U.S. Cl. CPC B60H 1/00742; B60H 1/00871

(57) ABSTRACT

A vent system for a vehicle includes a plurality of registers each having a power-actuated damper and a power-actuated airflow-directing shutter. A user interface is operatively linked to the power-actuated airflow-directing shutter. A controller is provided, adapted to automatically open the power-actuated damper of one or more of the plurality of registers disposed adjacent to an occupied vehicle seat. The user interface is adapted to control an orientation of the power-actuated airflow-directing shutter to direct an airflow to one of an upper zone, a middle zone, and a lower zone. The controller is adapted to translate the power-actuated damper between an open orientation and a closed orientation according to inputs received from one or more occupant location sensors. Methods for controlling a vehicle vent system are also described.

### TECHNICAL FIELD

This disclosure relates generally to vehicle heating, air-conditioning, and ventilation (HVAC) systems. More particularly, the disclosure relates to a control system for controlling and adjusting an HVAC airflow according to vehicle occupant location and preference.

### BACKGROUND

Various systems and mechanisms are provided in the modern vehicle for establishing and maintaining vehicle occupant comfort, primarily mediated by way of the vehicle heating, air-conditioning, and ventilation (HVAC) systems. In operating such systems and mechanisms, typically the vehicle occupant is required to exercise some element of manual control to adjust the mechanisms to his or her satisfaction. For example, on hot days the vehicle air-conditioning (AC) system is used to provide an acceptable passenger cabin internal temperature. Conditioned airflow from the HVAC system enters the passenger cabin via a number of registers disposed, for example, in the vehicle dash panel, on or near the floor, on a vehicle console, etc.

Vehicle registers commonly include a series of arrayed louvers which may be manipulated by vehicle occupants to direct an airflow therethrough to an occupant's satisfaction and/or to close the register to prevent an airflow therethrough. In turn, absent such action from a vehicle occupant, airflow enters the vehicle passenger cabin through all available registers regardless of the number and location of passengers in the vehicle. Thus, for example, even if the vehicle only has one or two occupants, HVAC airflow is provided for the entire vehicle as if all of the vehicle seats were occupied. This is wasteful of resources, and may impact vehicle fuel economy.

To solve this and other problems, the present disclosure relates at a high level to a vehicle vent control system and associated methods. Advantageously, when actuated the described vehicle vent control system automatically allows HVAC airflow only through registers positioned near occupied vehicle seats. The described vent control system further includes a user interface providing a means for a single vehicle occupant to direct the allowed HVAC airflow from any open register to particular zones corresponding to an occupant's head area, torso area, or leg area as desired.

### SUMMARY

In accordance with the purposes and benefits described herein, in one aspect of the present disclosure a vent system for a vehicle is provided, comprising a plurality of registers each comprising a power-actuated damper and a power-actuated airflow-directing shutter. A user interface is provided, operatively linked to the power-actuated airflow-directing shutter. Further, a controller is adapted to automatically open the power-actuated damper of one or more of the plurality of registers disposed adjacent to an occupied vehicle seat.

In embodiments, the power-actuated damper comprises one or more vertically-oriented louvers and the power-actuated airflow-directing shutter comprises one or more horizontally-oriented louvers. In other embodiments, the power-actuated damper and the power-actuated airflow-directing shutter each comprise a plurality of vertically-oriented louvers and horizontally-oriented louvers, respectively.

In embodiments, the user interface is adapted to control an orientation of the power-actuated airflow-directing shutter to direct an airflow to one of an upper zone, a middle zone, and a lower zone. The user interface may be selected from the group consisting of a touch display, a touch panel, a touchscreen, a lever, a switch, a conductive switch, a rotary twist knob, a slide, etc.

In embodiments, the controller may comprise one or more processors comprised in or communicating with the Body Control Module (BCM). The controller may determine an occupied vehicle seat by receipt of an input from one or more occupant location sensors. By these inputs providing an indication of seat occupancy, the controller determines whether to translate the power-actuated damper between an open orientation and a closed orientation to allow an airflow through a register or registers adjacent to an occupied vehicle seat. In embodiments, the one or more occupant location sensors are selected from the group consisting of a seat-mounted sensor, a seat-mounted pressure sensor, a camera, a proximity sensor, an infrared sensor, and others.

In another aspect of the disclosure, a vent system for a vehicle comprises a plurality of registers each including a damper comprising a plurality of power-actuated horizontal louvers and an airflow director comprising a plurality of power-actuated vertical louvers. The system further includes a plurality of seat occupant sensors. A user interface is operatively linked to the airflow director, and a controller is provided operatively linked to the airflow director of each of the plurality of registers. The controller is adapted to automatically open the damper of one or more of the plurality of registers disposed adjacent to a seat determined to be occupied by one or more of the plurality of seat occupant sensors.

In embodiments, the user interface is adapted to control an orientation of the plurality of power-actuated horizontal louvers to direct a register airflow to one of an upper zone, a middle zone, and a lower zone. The controller may comprise one or more processors comprised in or communicating with the Body Control Module (BCM).

In still another aspect, a method for controlling a vent system for a vehicle is provided, comprising steps of providing a plurality of registers each comprising power-actuated damper and a power-actuated airflow-directing shutter, providing a user interface operatively linked to the power-actuated airflow-directing shutter, and providing a controller adapted to automatically open the power-actuated damper of one or more of the plurality of registers disposed adjacent to an occupied vehicle seat.

The method includes steps of, by the user interface, orienting the power-actuated airflow-directing shutter and by the controller, translating the power-actuated damper between an open orientation and a closed orientation according to an input from one or more occupant location sensors. In embodiments, these steps may be undertaken sequentially, concurrently, or in an alternative order. The registers, power-actuated damper, power-actuated airflow-directing shutter, user interface, controller, and occupant location sensors may be substantially as described above.

In the following description, there are shown and described embodiments of the disclosed vent control system and associated methods. As it should be realized, the systems and methods are capable of other, different embodiments and its several details are capable of modification in various, obvious aspects all without departing from the devices and methods as set forth and described in the following claims. Accordingly, the drawings and descriptions should be regarded as illustrative in nature and not as restrictive.

### BRIEF DESCRIPTION OF THE DRAWINGS

The accompanying drawing figures incorporated herein and forming a part of the specification, illustrate several aspects of the disclosed vent control systems and methods, and together with the description serve to explain certain principles thereof. In the drawing:

FIG. 1 depicts a vehicle including a system for controlling a vent system according to the present disclosure;

FIG. 2 depicts a representative vent register for use in the system of FIG. 1;

FIG. 3A depicts a user interface for use in the system of FIG. 1;

FIG. 3B depicts a touch screen associated with the user interface of FIG. 3A; and

FIG. 4 depicts in flow chart form a method for controlling a vehicle vent system according to the present disclosure.

Reference will now be made in detail to embodiments of the disclosed vent control systems and methods, examples of which are illustrated in the accompanying drawing figures.

### DETAILED DESCRIPTION

Preliminarily, numerous HVAC systems, and methods and devices/mechanisms for controlling HVAC airflow and for controlling power-actuated registers are known in the art, and so need not be described in detail herein. Likewise, various sensors and detectors for determining a presence of a vehicle seat occupant are also well known and need not be described in detail herein. For example, a representative system for in-vehicle occupant detection is set forth in the present Assignee's U.S. Pat. No. 8,284,041 for Method and Apparatus for In-vehicle Presence Detection and Driver Alerting, the entire disclosure of which is incorporated herein by reference.

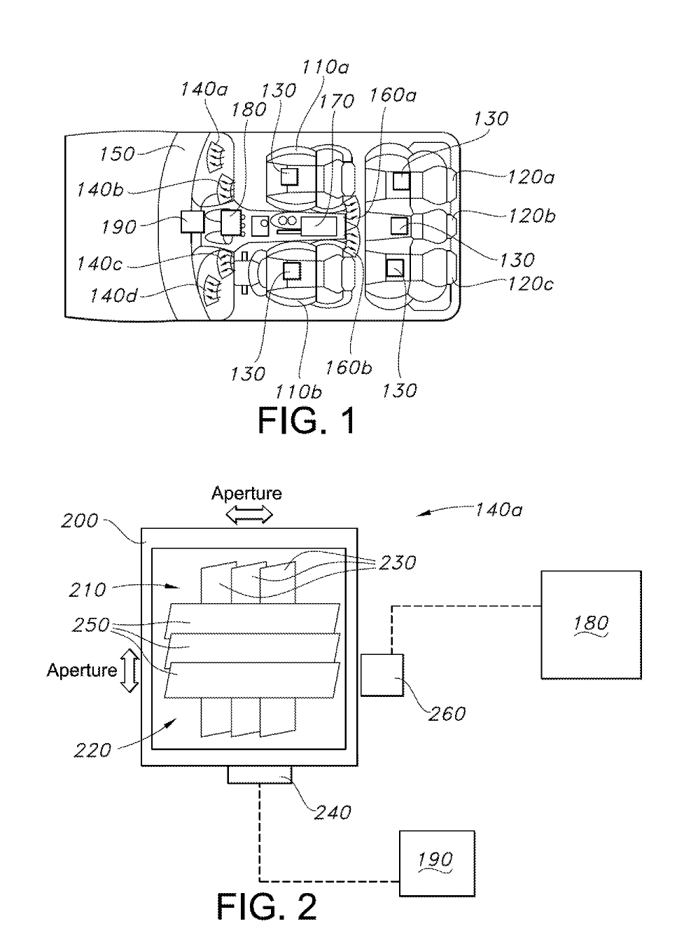

Turning now to FIG. 1, a representative motor vehicle 100 passenger cabin is depicted including at front seats 110a, 110b and rear seats 120a, 120b, 120c. Occupancy of each of front seats 110a, 110b and rear seats 120a, 120b, 120c is detectable by an occupant location sensor 130 adapted to determine the presence of a seat occupant. As will be appreciated, the occupant location sensor 130 may be as simple as a pressure switch embedded in the seat and adapted to detect the weight of a passenger, or may be more a complex mechanism such as a different type of seat-mounted sensor, one or more cameras disposed whereby a field of view thereof will determine the presence of a seat occupant, a proximity sensor, an infrared sensor, and others. Of course, it will be appreciated that more or fewer vehicle seats could be included according to vehicle size, passenger capacity, and other factors.

The vehicle further includes an array of vents, in the depicted embodiment including forward registers 140a, 140b, 140c, and 140d mounted in a dash panel 150 and oriented to direct an airflow towards front seats 110a, 110b. The array of vents further includes rear registers 160a, 160b mounted in a rear console 170 and oriented to direct an airflow towards rear seat 120. Of course, it will be appreciated that more or fewer registers could be included in the array of vents, according to vehicle size, passenger capacity, HVAC system capacity, and other factors. In turn, alternative or additional placement of registers is contemplated, for example mounted in one or more vehicle doors, in one or more overhead consoles, and others (embodiments not shown).

As will be described in greater detail below, the registers 140a-140d and 160a-160d are operatively linked to a user interface 180. In the depicted embodiment, as will be further described below the user interface 180 is a touch panel of known design. However, the skilled artisan will readily appreciate that numerous user interface 180 embodiments are possible and therefore contemplated, including without intending any limitation a touch display, a touch panel, a touchscreen, a lever, a switch, a conductive switch, a rotary twist knob, a slide, and others. As will be appreciated, by “operatively linked” it is meant that the user interface 180 may be used to cause actuation of at least a portion of the mechanisms of the registers 140a-140d and 160a-160d.

In turn, as will be described in greater detail below the registers 140a-140d and 160a-160d are also operatively linked to a controller 190 which in turn is configured to receive inputs from the occupant location sensor 130. In one possible embodiment, the controller 190 comprises one or more processors including storage and memory, and is comprised in the vehicle Body Control Module (BCM). However, it will be readily appreciated that in alternative embodiments the controller 190 may comprise an alternative processor, such as a dedicated Electronic Control Unit (ECU) operatively linked to the registers 140a-140d and 160a-160d and also communicating with another controller such as the BCM or other suitable vehicle controller. All such alternative embodiments are contemplated herein. As will be appreciated, by “operatively linked” it is meant that the controller 190 may be used to cause actuation of at least a portion of the mechanisms of the registers 140a-140d and 160a-160d.

With reference to FIG. 2 representatively depicting register 140a, each of the registers 140a-140d and 160a-160d is associated with an HVAC duct (not shown for convenience) and includes a housing 200 carrying a power-actuated damper 210 and a power-actuated airflow-directing shutter 220 each of which may be defined by at least one power-actuated louver operatively linked to an actuator such as a servo motor or other motor. In the depicted embodiment, the power-actuated damper 210 is defined by one or more vertically-oriented louvers 230 operatively linked to at least one servo motor 240 which in turn is under the operative control of the controller 190. Likewise, in the depicted embodiment the power-actuated airflow-directing shutter 220 is defined by a plurality of vertically-oriented louvers 250 operatively linked to at least one servo motor 260 which in turn is under the operative control of the user interface 180.

Returning to FIG. 1 showing the various vehicle seats and associated occupant location sensors, as will be appreciated when one or more users (not shown) occupy one or more of front seats 110a, 110b and rear seats 120a, 120b, 120c, the corresponding occupant location sensors 130 detect the presence of a passenger, and send an input indicative of that presence to controller 190. According to that input, the controller 190 directly or indirectly (for example, via one or more ECUs) provides a signal to actuate the appropriate power-actuated damper 210 to translate to a closed position to prevent airflow through any registers determined as being unoccupied. So, for example, if seats 110b and 120a are occupied, the occupant location sensors 130 associated with those seats send an input indicative of that occupancy to controller 190. In turn, controller 190 directly or indirectly provides a signal to actuate the servo motors 240 associated with any registers near seats 110a, 120b, and 120c to cause the vertical louvers 230 (see FIG. 2) of registers 140a, 140b, 160b to translate to a closed configuration, thereby allowing airflow only through the registers 140c, 140d, and 160a that are adjacent to the occupied vehicle seats 110b and 120a.

Of course, alternative embodiments are contemplated. For example, in the above example controller 190 causes vertical louvers 230 of registers 140a, 140b, 160b to translate to a closed configuration. Instead, controller 190 may directly or indirectly provide a signal to actuate the servo motors 240 associated with registers 140c, 140d, and 160a that are adjacent to the occupied vehicle seats 110b and 120a to cause the vertical louvers 230 of those registers to translate to an open configuration while causing the vertical louvers 230 of other vehicle registers to remain closed or to translate to a closed configuration. In yet another possible embodiment, all vertical louvers 230 of all registers may be maintained in a closed configuration until controller 190 receives an input indicative that particular vehicle seats are occupied, at which time the controller actuates the servo motors associated with any registers 140 adjacent to such occupied seats to translate to an open configuration.

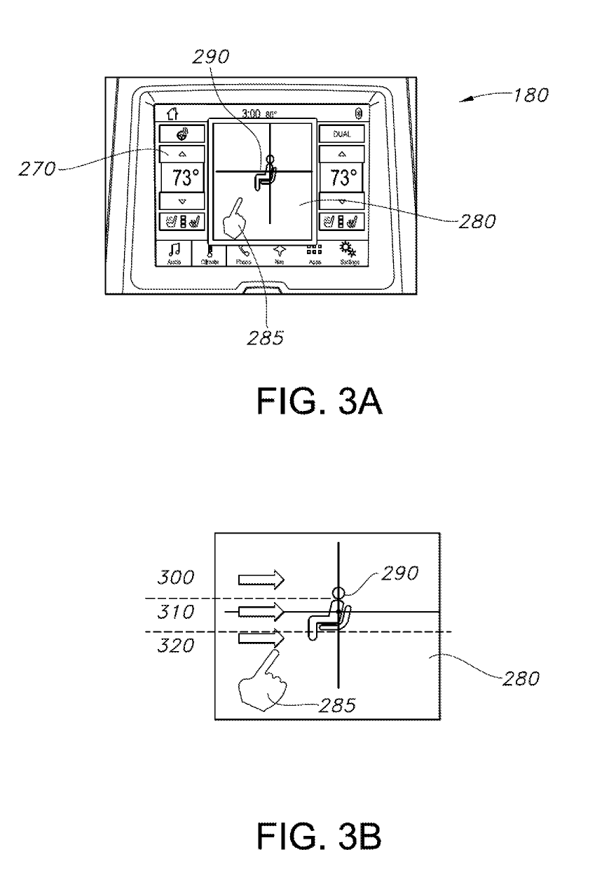

Another feature of the described vent control system will now be described. With reference to FIG. 3, in an embodiment the user interface 180 may be configured to include a display 270 comprising a screen 280 which, as is known, provides a convenient means for a user (represented by icon 285) to enter commands to operate various vehicle safety, communication, and entertainment features. It is contemplated for convenience to provide a touch-sensitive display 270 comprising a touch screen 280. The basic function of such touch displays is well known in the art, and does not require extensive discussion herein. One such suitable touch display 270 may be found in association with Ford Motor Company's SYNC® integrated in-vehicle communications and entertainment system, although others are known. However, it will be appreciated that alternative means of entering commands are contemplated, for example wherein a controller (not shown) is provided allowing a user to move icon 285 similarly to the operation of a computer mouse.

In the depicted embodiment shown in more detail in FIG. 3B, a processor (not shown) associated with the user interface 180 is configured to display an icon 290 representative of a seated passenger, and to divide the icon 290 into an upper zone 300, a middle zone 310, and a lower zone 320 representative of the passenger's head, torso, and legs. A user need only touch the icon 290 at one of the head (upper zone 300), the torso (middle zone 310) or the legs (lower zone 320) and, as will be described, a flow of air through one or more registers as described above is directed towards the selected area of a vehicle seat occupant, i.e. the head area, torso area, or leg area. Of course, alternative configurations of icon 290 satisfying this function of defining an upper zone 300, a middle zone 310, and a lower zone 320 are possible and contemplated.

As described above, when one or more users (not shown) occupy one or more of front seats 110a, 110b and rear seats 120a, 120b, 120c, the corresponding occupant location sensors 130 detect the presence of a passenger and send appropriate inputs to controller 190 whereby the power-actuated dampers 210 associated with the registers closest to the seats determined as being occupied allow airflow therethrough but the power-actuated dampers associated with any other registers are closed and prevent airflow therethrough. Using the above example of passengers occupying seats 110b and 120a whereby the power-actuated dampers 210 associated with registers 140c, 140c, and 160a remain open, a user by way of user interface 180 may then select a desired zone from upper zone 300, a middle zone 310, and lower zone 320 for airflow direction. The user interface 180 directly or indirectly via other ECUs provides a signal to actuate the servo motors 260 associated with registers 140c, 140c, and 160a, thus translating horizontal louvers 250 to an appropriate angle to direct airflow towards the selected one of upper zone 300, middle zone 310, and lower zone 320. So, if a user has selected upper zone 300, the user interface provides a signal to actuate the servo motors 260 associated with registers 140c, 140c, and 160a to translate the horizontal louvers 250 of those registers to an appropriate angle to direct airflow towards upper zone 300, i.e. the head area of the occupants of seats 110b and 120a.

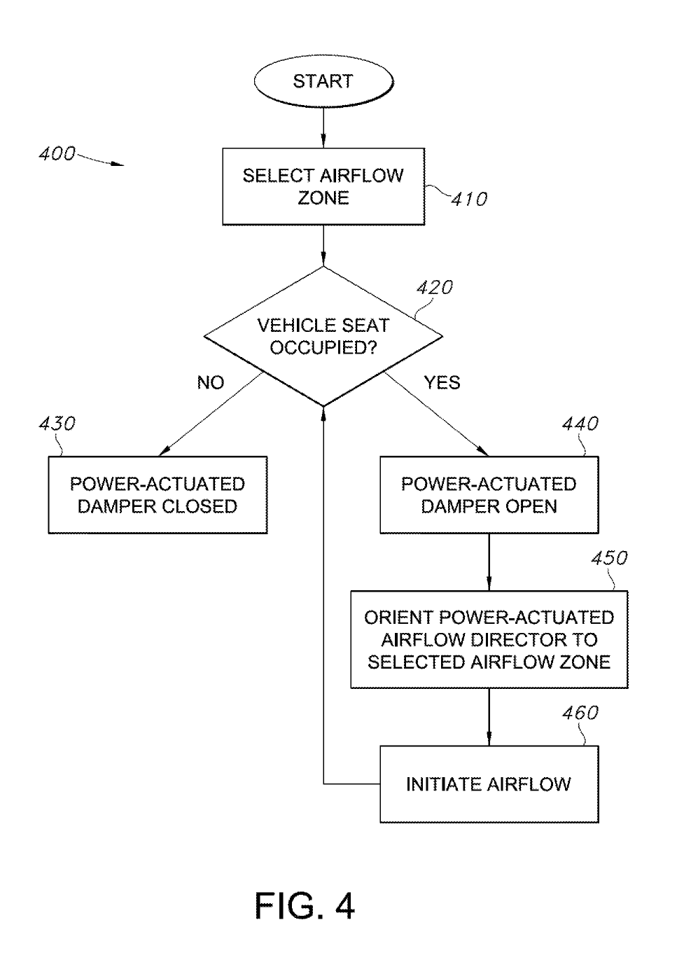

With reference to FIG. 4, in one possible embodiment of a method 400 for controlling a vehicle vent system using the mechanisms and systems described above, at step 410 a user may utilize user interface 180 to select a desired airflow zone (upper zone, middle zone, lower zone) as described above for any active registers 140, 160. At step 420, the controller 190 queries for inputs from occupant location sensors 130 to determine particular vehicle seats 110, 120 that are currently occupied. For each seat 110, 120, if the occupant location sensor 130 input provided to the controller 190 indicates that the seat is unoccupied, the controller 190 at step 430 causes the respective power-actuated damper 210 of the registers 140, 160 closest to that seat 110, 120 to translate to a closed position, preventing airflow through those registers. On the other hand, if the occupant location sensor 130 input provided to the controller 190 indicates that a seat 110, 120 is occupied, the controller 190 at step 440 ensures that the respective power-actuated damper 210 of the registers 140, 160 closest to that seat 110, 120 has translated to an open position, allowing airflow through those registers.

Continuing, at step 450, as described above the power-actuated airflow-directing shutter 220 for each active register 140, 160, i.e. for each register having an open power-actuated damper 210, is translated to the desired orientation to provide the selected airflow direction, i.e. to upper zone 300 directed towards a seat occupant's head area, to middle zone 310 directed towards a seat occupant's torso area, or to lower zone 320 directed towards a seat occupant's leg area. At step 460, airflow is initiated through the respective active registers 140, 160.

Of course, seat 110, 120 occupancy status may change. For example, a passenger may exit the vehicle 100 and a different passenger enter, to occupy the same or a different seat 112, 120. Therefore, the above process 400 may be repeated (i.e. return to step 420) at predetermined intervals to verify that a seat 110, 120 previously determined as being occupied remains occupied, and therefore that the active registers 140, 160 should remain the same or be changed. Alternatively, the process may repeat only when necessary, i.e. when a specific occupant location sensor 130 sends an input indicative that a previously occupied seat 110, 120 has become unoccupied. Likewise, the process 400 may restart at step 410 (select a desired airflow zone) when a user inputs a different command to user interface 180.

Obvious modifications and variations are possible in light of the above teachings. For example, as described above more or fewer registers and/or alternative register placements are contemplated according to vehicle size, style, and available packaging space. While power-actuated dampers and power-actuated airflow-directing shutters are described comprising a plurality of power-actuated louvers, it will readily be appreciated that the same function could be performed by more or fewer louvers, for example power-actuated dampers and power-actuated airflow directing shutters each comprising a single power-actuated panel.

In turn, while servo motors are described for controlling an orientation of the power-actuated dampers and power-actuated airflow-directing shutters, alternative mechanisms for controlling power-actuated louvers are known in the art, and are contemplated for user herein. Still more, in a non-autonomous vehicle, i.e. a self-driving/self-navigating, it can be presumed that at least seat 110b (the driver's seat) will always be occupied when the vehicle 100 is being operated. Therefore, the occupant location sensor 130 and other mechanisms associated with registers 140c, 140d nearest the driver's seat could be omitted from the above-described systems and methods.

Still more, the method 400 for controlling a vehicle vent system is described above as proceeding sequentially. However, it will be appreciated that the recited steps could proceed in a different order, for example wherein the order of steps 410 (select a desired airflow zone) and 420 (determine a vehicle seat occupancy status) are reversed. As yet another alternative, the steps could occur substantially simultaneously, such as at vehicle 100 start-up.

All such modifications and variations are within the scope of the appended claims when interpreted in accordance with the breadth to which they are fairly, legally and equitably entitled.

What is claimed:

1. A vent system for a vehicle, comprising:
a plurality of registers each comprising a power-actuated damper and a power-actuated airflow-directing shutter;
a user interface operatively linked to the power-actuated airflow-directing shutter; and
a controller adapted to automatically open the power-actuated damper of one or more of the plurality of registers disposed adjacent to an occupied vehicle seat.

2. The system of claim 1, wherein the power-actuated damper comprises one or more vertically-oriented louvers.

3. The system of claim 1, wherein the user interface is adapted to control an orientation of the power-actuated airflow-directing shutter to direct an airflow to one of an upper zone, a middle zone, and a lower zone.

4. The system of claim 3, wherein the power-actuated airflow-directing shutter comprises one or more horizontally-oriented louvers.

5. The system of claim 3, wherein the user interface is selected from the group consisting of a touch display, a touch panel, a touchscreen, a lever, a switch, a conductive switch, a rotary twist knob, and a slide.

6. The system of claim 1, wherein the controller determines an occupied vehicle seat by an input from one or more occupant location sensors.

7. The system of claim 6, wherein the controller is adapted to translate the power-actuated damper between an open orientation and a closed orientation according to the input from the one or more occupant location sensors.

8. The system of claim 6, wherein the controller comprises one or more processors comprised in or communicating with a Body Control Module (BCM).

9. The system of claim 6, wherein the one or more occupant location sensors are selected from the group consisting of a seat-mounted sensor, a seat-mounted pressure sensor, a camera, a proximity sensor, and an infrared sensor.

10. The system of claim 1, wherein the plurality of registers each comprise a plurality of power-actuated horizontally oriented louvers and a plurality of power-actuated vertically-oriented louvers.

11. A vent system for a vehicle, comprising:
a plurality of registers each including a damper comprising a plurality of power-actuated horizontal louvers and an airflow director comprising a plurality of power-actuated vertical louvers;
a plurality of seat occupant sensors;
a user interface operatively linked to the airflow director; and
a controller adapted to automatically open the damper of one or more of the plurality of registers disposed adjacent to a seat determined to be occupied by one or more of the plurality of seat occupant sensors.

12. The system of claim 11, wherein the user interface is adapted to control an orientation of the plurality of power-actuated horizontal louvers to direct a register airflow to one of an upper zone, a middle zone, and a lower zone.

13. The system of claim 11, wherein the controller comprises one or more processors comprised in or communicating with a Body Control Module (BCM).

14. A method for controlling a vent system for a vehicle, comprising:
providing a plurality of registers each comprising power-actuated damper and a power-actuated airflow-directing shutter;
providing a user interface operatively linked to the power-actuated airflow-directing shutter; and
providing a controller adapted to automatically open the power-actuated damper of one or more of the plurality of registers disposed adjacent to an occupied vehicle seat.

15. The method of claim 14 including, by the user interface, orienting the power-actuated airflow-directing shutter.

16. The method of claim 15, including selecting the user interface from the group consisting of a touch display, a touch panel, a touchscreen, a lever, a switch, a conductive switch, a rotary twist knob, and a slide.

17. The method of claim 14, including providing the controller comprising one or more processors comprised in or communicating with a Body Control Module (BCM).

18. The method of claim 14 including, by the controller, translating the power-actuated damper between an open orientation and a closed orientation according to an input from one or more occupant location sensors.

19. The method of claim 18, including selecting the one or more occupant location sensors from the group consisting of a seat-mounted sensor, a seat-mounted pressure sensor, a camera, a proximity sensor, and an infrared sensor.

20. The method of claim 14, including providing the power-actuated airflow-directing shutter comprising a plurality of power-actuated horizontal louvers and the power-actuated damper comprising a plurality of power-actuated vertical louvers.
